(19) United States
(12) Patent Application Publication
(10) Pub. No.: US 2024/0066812 A1
(43) Pub. Date: Feb. 29, 2024

(54) HELICALLY COMPRESSED SHEET FILMS AND COEXTRUSIONS FOR IMPROVED RESISTANCE TO PERMEATION AND DIFFUSION BY MULTILAYER TUBULAR COMPOSITE STRUCTURE

(71) Applicant: BrainDrip LLC, Jacksonville, FL (US)

(72) Inventor: KENT Weisenberg, Jacksonville, FL (US)

(73) Assignee: BrainDrip LLC, Jacksonville, FL (US)

(21) Appl. No.: 18/240,598

(22) Filed: Aug. 31, 2023

Related U.S. Application Data
(60) Provisional application No. 63/374,023, filed on Aug. 31, 2022.

(51) Int. Cl. B29C 70/68; B29C 48/00; B29C 48/151; B29C 48/18; F16L 9/12

(52) U.S. Cl. CPC B29C 70/68; B29C 48/022; B29C 48/151; B29C 48/18; F16L 9/12; B29L 2023/00

(57) ABSTRACT

Disclosed herein are cannular assemblies composed of multiple concentric layers of sealing, reinforcement, sensing and monitoring components, pressure injected fluids, and over-molded structural and protection layers. An innermost sealing layer is provided with an optional overlay for improved resistance to diffusion and permeation. Either of the sealing layer or optional overlay, or both, is fabricated with permeation-resistant material. Also disclosed are related methods of manufacture.

### CROSS-REFERENCE TO RELATED APPLICATIONS

This application claims priority to U.S. Provisional Patent Application No. 63/374,023, filed 31 Aug. 2022, the contents of which are incorporated herein by reference in its entirety.

### FIELD OF THE INVENTION

The disclosed concept relates generally to a tubular composite structure for the intake, storage, and conveyance of gaseous or liquid media, including but not limited to hydrogen, hydrocarbons, and non-hydrocarbons, and related methods for manufacture. The tubular composite structure consists of one or more cannular assemblies, each composed of multiple layers of sealing, reinforcement, sensing and monitoring components, pressure injected fluids, and over-molded structural and protection layers.

### BACKGROUND OF THE INVENTION

Certain flexible composite liners are currently in use both for gaseous pipelines and pipeline rehabilitation. Typically, these liners are prefabricated in a straight orientation and are spooled post-fabrication for transport to the jobsite on spools. This manufacture process leads to deficiencies, both in the diameter of the liner (generally limited to 10 inches or smaller), and in the requirement to introduce curvature post-fabrication which imposes limitations on the pressure that can be accommodated. In contrast, tubular composites disclosed herein are manufactured on-site, obviating the limitations imposed by transportation. These tubular composites can have a larger diameter, due to their onsite manufacture, unconstrained by transport restrictions. Furthermore, intrinsic curvature can be introduced into these tubular composites during on-site manufacture, which affords stronger tubes than can be obtained by bending or deforming a straight tube into a curved shape.

Multilayer tubular composite structures are suitable for use as gaseous pipelines or to remediate existing pipelines. Media contained within the tubular composite may consist of commercially or industrial important gases and liquids, including but not limited to hydrogen, hydrocarbon, and non-hydrocarbon. The tubular composite may be particularly valuable for gases and liquids relevant to renewable energy sources, including hydrogen, natural gas, natural gas/hydrogen mixtures, renewable natural gas, ammonia, and carbon dioxide. The media may be at ambient pressure or may be pressurized. The structure can be positioned either above ground, sub-terra, or sub-terra with multiple tiers of individual coils, and can be located at end-user industrial facilities such as hydrogen production facilities terminals, power plants, mining operations or data centers. The structure can be installed expeditiously and with materials and methodologies that afford a meaningful reduction in carbon emissions over existing technologies.

The tubular composite consists of one or more cannular assemblies disclosed herein, each composed of multiple concentric layers of sealing, reinforcement, sensing and monitoring components, pressure injected fluids, and over-molded structural and protection layers. The cannular assemblies are manufactured individually. In the case of two or more cannular assemblies in a single tubular composite, the first cannular assembly will form the exterior of the tubular composite, with each successive cannular assembly inserted in the interior of the tubular composite and pushed and/or pulled into place into the one or more existing, fully manufactured, cannular assemblies.

In a preferred embodiment of the tubular composite structure, each cannular assembly comprises the following layers, progressing outward: (a) a sealing layer, primarily responsible for resistance to leakage of media; (b) an axial reinforcement layer; providing strength in the axial (longitudinal) direction; and (c) a hoop reinforcement layer; providing strength in the circumferential direction. Variations on this basic design include multiples of one or more layers, particularly the hoop reinforcement layer, incorporation of devices for sensing and troubleshooting, either embedded in an existing layer or as a separate layer, a mesh-filled annulus for post-fabrication injection of resin, and an exterior protective layer, comprising a fiber reinforced material or an over-mold resin. The particulars for each tubular composite structure can be chosen to best meet the needs of a certain application.

The sealing layer is a functional layer installed and located on the innermost surface of each cannular assembly in the tubular composite structure. The sealing layer provides watertightness, and acts as a redundant leak safeguard and for increasing the buckling resistance in the final cohesive composite structure. The sealing layers can provide an impermeable barrier to the material stored within the tubular composite structure, and can be made from materials with specific resistance and non-adherence to the media being stored in the structure.

Sealing layers can be made from plastic sheet materials. By way of example only, the plastic sheet material can be chosen from ABS, PE, HDPE, UHMWPE, Nylon, PEEK, PET, PSS, PDA, ETFE polycarbonate, and polyurethane. By way of example only, the plastic sheet material for hydrogen transmission may be traditional or recycled and modified PET or Bio-based with polymeric nanocomposite with an organo-modified clay additive or graphene/graphene oxide or graphene derivatives. In certain embodiments, thinner fiber reinforced flat sheet feedstock material such as reinforced PEEK or Nylon or similar that has been pre-etched radially for corrugation or radially etched can be employed. In addition, the sealing layer can utilize recycled plastics, bio-based materials, and low emission materials as feedstock, which will significantly reduce the overall carbon footprint of the manufactures, their manufacture and the installation equipment and methodologies disclosed herein.

Permeation of tubular composite structures by liquid or, particularly, gaseous media contained within is a concern, as it is for any pipeline. Not only does loss of media through the walls of a pipeline represent loss of product, but it can present a hazard to safety and/or health. Due to this concern, the innermost impermeable sealing layer of the tubular composite structure is primarily responsible for containment of media within the structure. An advantage of the tubular composite structure design is that each layer can individually provide one or more properties that is required by the structure. Accordingly, since outer layers of the tubular composite structure can provide the required strength and rigidity, the sealing layer can be selected for its resistance to permeation.

A complication to maintaining resistance to permeation is due to the heat that is generated in the tubular composite structure from repetitive filling and emptying of the structure. Injection of gas into the structure will likely be performed under pressure, in order to take full advantage of the capacity of the structure. Compression of the gas will necessarily raise its temperature, which will warm the structure. Over time, application of heat to the sealing layer will degrade its permeation and diffusion resistance.

There remains a need both to improve the permeation resistance of the sealing layer, in order to reduce the risk to safety and health from unwanted leakage of media, and to maintain this resistance during repeated cycles of usage.

### SUMMARY OF THE INVENTION

These needs, and others, are met by incorporation of an overlay or sealing layer coextrusion of a permeation-resistant material onto the exterior of or incorporation into the interior of the sealing layer. Choice of the material for fabrication of the overlay or coextrusion can be determined by the particular gas being contained in the structure. A wide variety of materials are available for fabrication of the overlay or coextrusion, including but not limited to poly(vinylidene dichloride) (“PVDC”), polyolefin, titanium oxide, aluminum oxide or nanocomposite metal hybrids. The overlay or coextrusion will provide several benefits, including but not limited to increased resistance to permeation by the gas contained within.

### DETAILED DESCRIPTION OF THE INVENTION

Provided herein, in an exemplary embodiment, is a tubular composite structure that comprise an overlay of a film with enhanced resistance to permeation and/or improved robustness on the exterior of the sealing layer.

Also provided herein, in an exemplary embodiment, is a cannular assembly, comprising from innermost surface to outermost surface:
(a) a sealing layer,
(b) an optional overlay fabricated from a permeation-resistant material,
(c) an axial reinforcement layer,
(d) one or more hoop reinforcement layers, and
(e) a protective layer,
wherein at least one layer chosen from the sealing layer and the overlay is fabricated from a permeation-resistant material.

In some embodiments, the cannular assembly comprises an overlay layer fabricated from a permeation-resistant material.

In some embodiments, the sealing layer is fabricated from a permeation-resistant material. In some embodiments, the sealing layer is a coextrusion with a permeation-resistant material. In some embodiments, the sealing layer coextrusion comprises a permeation-resistant material located on the interior of the sealing layer. In some embodiments, the sealing layer coextrusion comprises a permeation-resistant material located on the exterior of the sealing layer.

In some embodiments, the sealing layer comprises:
a first sub-layer, fabricated from a first resin material, and
a second sub-layer, fabricated from a mixture of a second resin material and a permeation-resistant material.

In some embodiments, the second sub-layer is located on the interior surface of the sealing layer. In some embodiments, the second sub-layer is located on the exterior surface of the sealing layer.

In some embodiments, the sealing layer comprises:
a first sub-layer, fabricated from a first resin material,
a second sub-layer, fabricated from a mixture of a second resin material and a permeation-resistant material, located on the interior surface of the sealing layer, and
a third sub-layer, fabricated from a mixture of the second resin material and a permeation-resistant material, located on the exterior surface of the sealing layer.

In some embodiments, the first resin material and the second resin material are the same.

In some embodiments, the first resin material and the second resin material are different. In some embodiments, the permeability coefficient of methane through the permeation-resistant material is 10×10⁻⁹ mol/(m×s×MPa) or less, optionally 5×10⁻⁹ mol/(m×s×MPa) or less, optionally 3×10⁻⁹ mol/(m×s×MPa) or less, optionally 2×10⁻⁹ mol/(m×s×MPa) or less.

In some embodiments, the permeability coefficient of hydrogen through the permeation-resistant material is 10×10⁻⁹ mol/(m×s×MPa) or less, optionally 5×10⁻⁹ mol/(m×s×MPa) or less, optionally 3×10⁻⁹ mol/(m×s×MPa) or less, optionally 2×10⁻⁹ mol/(m×s×MPa) or less.

In some embodiments, the permeability coefficient of ammonia through the permeation-resistant material is 10×10⁻⁹ mol/(m×s×MPa) or less, optionally 5×10⁻⁹ mol/(m×s×MPa) or less, optionally 3×10⁻⁹ mol/(m×s×MPa) or less, optionally 2×10 mol/(m×s×MPa) or less.

In some embodiments, the permeability coefficient of carbon dioxide through the permeation-resistant material is 10×10⁻⁹ mol/(m×s×MPa) or less, optionally 5×10⁻⁹ mol/(m×s×MPa) or less, optionally 3×10⁻⁹ mol/(m×s×MPa) or less, optionally 2×10⁻⁹ mol/(m×s×MPa) or less.

In some embodiments, the permeability coefficient is for the material at 0° C. In some embodiments, the permeability coefficient is for the material at 20° C. In some embodiments, the permeability coefficient is for the material at 40° C. In some embodiments, the permeability coefficient is for the material at 60° C. In some embodiments, the permeability coefficient is for the material at 80° C. In some embodiments, the permeability coefficient is for the material at 100° C.

In some embodiments, the permeation-resistant material is PVDC.

Also disclosed herein are related methods of manufacture.

Also disclosed herein are machines for performing the methods of manufacture.

Abbreviations

ABS=acrylonitrile butadiene styrene plastic; AI=artificial intelligence; AMV=Autonomous Manufacturing Vehicle; cmHg=centimeters of mercury; CV=computer vision; ETFE=Ethylene tetrafluoroethylene; FAME=fatty acid methyl ester; GNSS=Global Navigation Satellite System; GPS=Global Positioning System; ID=inner diameter=inside diameter; MIG=metal inert gas welding; ML=machine learning; MOF=mobile onsite factory; OD=outer diameter=outside diameter; PDA=poly(diacetylene); PE=polyethylene; UHMWPE=ultra high molecular weight polyethylene; HDPE=high density polyethylene; LDPE=low density polyethylene; PEEK=Polyether ether ketone; PLA=poly(lactic acid); PLLA=poly(L-lactic acid); PPL=poly(polypropiolactone); PSS=poly(styrene sulfonate); PVDC=poly(vinylidene dichloride); SMAW=shielded metal arc welding; STP=standard temperature and pressure; TCS=tubular composite structure; TDC=track drive carrier; TIG=tungsten inert gas welding; Torr=mmHg=millimeters of mercury; UHMWPE=Ultrahigh-molecular-weight polyethylene; UT=ultrasonic; UV=ultraviolet.

### Definitions

The term “annulus”, as used herein, alone or in combination, refers to a region between two concentric circles. The term “annular cylinder”, as used herein, alone or in combination, refers to a region between two concentric cylinders. The term “interspatial annular cylinder”, as used herein, alone or in combination, refers to an empty region between two concentric cylinders. In some embodiments, the interspatial annular cylinder can be filled with a liquid. In some embodiments, the liquid within an interspatial annular cylinder can then be cured, to form a solid, gel, or semi-solid.

The term “axial”, as used herein, alone or in combination, refers to the direction parallel to a tube or cylinder. For the case of a nonlinear or coiled tube or cylinder, the term refers to the direction at a point on the tube or cylinder that is parallel to the tube or cylinder at that point.

The term “concentric”, as used herein, alone or in combination, refers to two circular or cannular structures which share approximately the same center. The term “concentric” will also refer to two tubes which share approximately the same center, both of which tubes then form a coiled geometry.

The term “cylinder”, as used herein, refers to the standard geometric definition of a prism with a circle at its base. It will be appreciated that some of the articles of manufacture described herein may be susceptible to forces, e.g., gravity, which distort the ideal cylindrical shape. The term “cylinder”, as used herein, will also cover these articles of manufacture.

The term “cannular assembly”, as used herein, alone or in combination, refers to an assembly of concentric tubes. In some embodiments, a cannular assembly comprises, from innermost surface to outermost surface: (b) an axial reinforcement layer, and (c) one or more hoop reinforcement layers. In some embodiments, a cannular assembly comprises, from innermost surface to outermost surface: (a) a sealing layer, (b) an axial reinforcement layer, and (c) one or more hoop reinforcement layers. In some embodiments, a cannular assembly comprises, from innermost surface to outermost surface: (b) an axial reinforcement layer, (c) one or more hoop reinforcement layers, and (d) a protective layer. In some embodiments, a cannular assembly comprises, from innermost surface to outermost surface: (a) a sealing layer, (b) an axial reinforcement layer, (c) one or more hoop reinforcement layers, and (d) a protective layer. In some embodiments, the cannular assembly further comprises an overlay exterior to the sealing layer. In some embodiments, a cannular assembly further comprises one or more sensor array layers. In some embodiments, the axial layer in a cannular assembly comprises a Pd- or Pd-alloy coated tapered optical fiber. In some embodiments, one or more hoop reinforcement layers in a cannular assembly comprises a Pd- or Pd-alloy coated tapered optical fiber.

The term “downstream”, as used herein, refers to a direction along the mandrel away from the supported end and towards the unsupported end. The term “downstream” may also be used for a location that is outside the length of the mandrel on the side of the unsupported end of the mandrel. The term “upstream”, as used herein, refers to a direction along the mandrel away from the unsupported end of the mandrel and towards the supported end. The term “upstream” may also be used for a location that is outside the length of the mandrel on the side of the supported end of the mandrel.

The term “tubular composite structure” (“TCS”), as used herein, alone or in combination, refers to a structure containing one or more concentric cannular assemblies. In some embodiments, the TCS contains 1, 2, 3, 4, or 5 concentric cannular assemblies. The cannular assemblies may be the same or different. In some embodiments, the tubular composite structure comprises one or more interspatial annular cylinders between adjacent cannular assemblies.

The term “innervated tubular composite” (“ITC”), as used herein, alone or in combination, refers to a tubular composite structure contains one or more sensor array layers or one or more sensor wires. In some embodiments, the ITC contains one or more sensor array layers and one or more sensor wires. The ITC is therefore can provide telemetry on its condition to the user. In some embodiments, the ITC can report conditions chosen from structural integrity, internal pressure, presence of leaks, and extent of leakage.

The tem “coiled-tube structure”, as used herein, alone or in combination, refers to a coiled tubular composite structure.

The term “forming mandrel” or “mandrel”, as used herein, refers to a horizontally oriented tube that is cantilevered, i.e., directly supported at only one end. The mandrel is manufactured so that a hoop or cylinder enclosing the mandrel at the supported end can pass down the length of the mandrel unobstructed to the unsupported end. A mandrel can be optionally solid, but is preferentially hollow. A mandrel can consist of a single monolithic structure. Alternatively, a mandrel can be composed of segments, one or more of which can optionally be translated and/or rotated relative to adjacent segments. A mandrel can be linear, or can assume a non-linear geometry. A mandrel composed of multiple segments can be articulated either actively, by powered drives located in the mandrel, or passively, via contact forces applied to the exterior of the mandrel.

The term “intrinsic curvature”, as used herein, alone or in combination, refers to an article of manufacture which, in the absence of external force, assumes a curved geometry. The term is therefore intended to include an article of manufacture whose manufacture comprised a step of introducing curvature concurrent with manufacture. The term is therefore intended to exclude an article of manufacture whose manufacture comprises a step of introducing curvature into a non-curved precursor of the article. The term is also therefore intended to exclude an article of manufacture whose manufacture comprises a step of increasing the curvature, i.e., decreasing the radius of curvature, into a less-curved precursor of the article (i.e., having a smaller radius of curvature).

The term “permeability coefficient”, abbreviated Cₚ, as used herein, alone or in combination, refers to the measure of permeability for a gas through a substance. Units of permeability coefficient are: (number of moles/unit time/(thickness×pressure). Any suitable units for these measures may be chosen. For example, time can be measured in seconds (s), thickness in meters (m), and pressure in megapascals (MPa). Optionally, Cₚ can be provided in units of mol/(m×s×MPa). The flow of gas (in moles n per unit time) through a layer of material with area A, thickness d, and with a pressure differential P can be found with the permeability coefficient Cₚ:

Flow of gas (moles/time)=(A×P/d)×Cₚ

Alternatively, the permeability coefficient can be expressed units of volume/(thickness×pressure). For example, permeability may be provided in barrer units, which are defined as 10⁻¹⁰ cm³ (STP) cm/(cm² s cmHg). The flow of gas (in cm³/sec) at STP through a layer of material with area A (in cm²), thickness d (in cm), and with a pressure differential P (in cmHg) can be found with the permeability coefficient Cₚ in barrier units:

Flow of gas (cm³/sec)=(A×P/d)×Cₚ

The terms “pitch”, “roll”, and “yaw”, as used herein, have their standard meanings as used, for example, in aviation. The direction of the advancing growing tubular composite structure can be considered as the forward direction.

The term “radius of curvature”, as used herein, alone or in combination, refers to the radius of a circle whose curvature best approximates the curvature at a particular location on an arc.

The term “wire”, as used herein, alone or in combination, refers to a means for transmitting either information or electrical current over distance. The term therefore encompasses traditional wire based on copper, aluminum, or other conducting metal. The term therefore also encompasses fibers for the transmission of information without electrical current, and thus encompasses optical fibers.

Forming Mandrel

Also provided herein, in an exemplary embodiment, is a cantilevered forming mandrel for the manufacture of a tubular composite structure.

In some embodiments, the mandrel is monolithic. In some embodiments, the mandrel comprises a plurality of segments positioned successively from the supported, upstream end to the unsupported, downstream end. In some embodiments, the segments are substantially cylindrical in shape.

In some embodiments, the mandrel is substantially linear. In some embodiments, the mandrel is substantially curved. In some embodiments, the curvature of the mandrel can be varied. In some embodiments, the mandrel can be varied between curved geometries of different radii of curvature. In some embodiments, the mandrel can be varied between curved geometries of different radii of curvature during manufacture of the cannular assembly. In some embodiments, the mandrel can be varied between linear and curved.

In some embodiments, the exterior of the mandrel is substantially cylindrical in shape. In some embodiments, the exterior of the mandrel is substantially the shape of toroidal segment.

In some embodiments, the mandrel is solid or, alternatively, is composed of solid segments.

In some embodiments, the mandrel is hollow or, alternatively, is composed of hollow segments.

The dimensions of the mandrel will be determined by the nature of the tubular composite to be manufactured. The OD of the mandrel is the same or approximately the same as the desired ID of the tubular composite to be manufactured. Preferably, the OD of the mandrel can be adjusted to suit the on the required design of the cannular assembly. The length of the mandrel is determined by the number and size of the various stations, which in turn is determined by the makeup of the tubular composite.

Mobile Onsite Factory (“MOF)

Also provided herein is a mobile onsite factory (“MOF”), comprising machinery for manufacturing a cannular assembly. The MOF comprises the forming mandrel and the stations exterior to the mandrel for the manufacture of the various layers of the structure. The MOF can be towed or, alternatively, self-propelled and powered by hydrogen, battery, hydrogen/battery, or traditional fuels. In some embodiments, the structure is appointed to its site as it is being manufactured, with the growing structure being directed to its destination.

AMV

Also provided herein is a variation of the MOF, termed autonomous manufacturing vehicle (“AMV”). The AMV uses an articulated design, with individual segments that can rotate and/or translate relative to each other. In some embodiments, the AMV contains a plurality of independently pivoting segments, each of which corresponds to a segment of the mandrel, and on each of which a single station for manufacture of a single layer of the tubular composite can be mounted.

Sealing Layer

The sealing layers are functional layers installed and located on the innermost surface of each cannular assembly in the tubular composite structure. The sealing layers provide watertightness, and act as a redundant leak safeguard and for increasing the buckling resistance in the final cohesive composite structure.

Since the hoop reinforcement layer, described below, provides exterior reinforcement of the sealing layer, outward strain applied to the sealing layer due to internal fluid or gas pressurization during service the sealing layer is completely constrained from causing separation, damage, or rupture by the hoop reinforcement layer. The sealing layer material is therefore only subjected to compression, to which it has a high resistance. This design parameter ensures that any short term, long-term or transient loading on the sealing layer material and the seam is far below the material's physical properties thus eliminating any potential for separation, creep, cracking or rupture as well as significantly mitigating long term material fatigue. The sealing layer must have sufficient strength to withstand manipulation from stock material, typically supplied on spools, into the cylindrical shape required for providing the inner layer on the surface of the mandrel.

The sealing layers can provide an impermeable barrier to the material stored within the tubular composite structure, and can be made from materials with specific resistance and non-adherence to the media being stored in the structure. Embodiments containing one or more cannular assemblies, each assembly containing a sealing layer on its innermost surface, are contemplated in this disclosure, depending on the required pressure resistance and/or the required number and types of flowable, and optionally curable, materials in the interspatial annular cylinder. The most internal sealing layer may also be constructed of materials that are highly hydrophobic or oleophobic to allow for the release of media when cleaning or batching different media to significantly reduce FAME and contaminants.

Individual sealing layers on different cannular assemblies can be made from different materials. Sealing layers can be made from plastic sheet materials. By way of example only, the plastic sheet material can be chosen from ABS, PE, HDPE, UHMWPE, Nylon, PEEK, PET, PSS, PDA, ETFE polycarbonate, and polyurethane, or mixtures thereof. By way of example only, the plastic sheet material for hydrogen transmission may be traditional or recycled and modified PET or Bio-based with polymeric nanocomposite with an organo-modified clay additive or graphene/graphene oxide or graphene derivatives. In certain embodiments, thinner fiber reinforced flat sheet feedstock material such as reinforced PEEK or Nylon or similar that has been pre-etched radially for corrugation or radially etched can be employed. Methods disclosed herein may utilize highly reinforced plastics and metal sheet stock. Material for the sealing layer in the innermost cannular structure of the TCS may be chosen based on one or more of the following variables: cost, non-adherence, chemical or erosion resistance to the transmitted pipeline media, modulus for buckling resistance, and (when applicable) heat resistance to the application of cold spray metalizing and thermal processes or resistance to the pipeline media. Unlike current and lesser methods, and in consideration of the flat sheet feedstock methodology utilized in the materials and methods disclosed herein, the ability to utilize any material composition affords the capability to also utilize recycled plastics and bio-based materials, which will significantly reduce the overall carbon footprint of the manufactures, their manufacture and the installation equipment and methodologies disclosed herein. While the methods and manufactures disclosed herein retain the capability to use traditional petroleum polymerization derived materials such as HDPE or a hybrid of these traditional materials and recycled or bio-based materials, they can also utilize a high fraction of recycled, bio-based, and low emission materials. In some embodiments, recycled, bio-based, and low emission materials constitute 50% or more of the materials used in a method or manufacture. In some embodiments, recycled, bio-based, and low emission materials constitute 75% or more of the materials used in a method or manufacture. In some embodiments, recycled, bio-based, and low emission materials constitute 90% or more of the materials used in a method or manufacture.

By way of example, recycled, bio-based, and low emission materials that may be used in the methods and materials disclosed herein may include recycled materials such as polyethylene terephthalate (PET) plastic, including PET from recycled water bottles and other PET and similar recycled plastics and products. Additionally, bio-based materials that may be used in the methods and materials disclosed herein may include but are not limited to: PLA homopolymers (polylactic acid) and variants, such as PLLA, PPLA or “green” high density polyethylene. Many of these augmented bio-based and recycled materials have high dimensional stability, impact, moisture, alcohol and solvent resistance and often higher mechanical properties than their traditional petroleum-based counterparts. This makes them ideal for utilization in these tubular composite structures disclosed herein, and in turn be part of solution for carbon reducing and carbon neutral technologies. By example, the efficacy of carbon reductions made possible by the methods and manufactures disclosed herein, in only one mile of 12-inch diameter of TCS the entire TCS would utilize the recycled materials from nearly 3.5 million-12-ounce plastic water bottles or the sequestering of 20 tons of carbon dioxide in its manufacture. It should be noted again that, by design, all past and current storage systems cannot utilize these low carbon emission materials due to the “off the shelf” prefabricated cylinders or pipes that are used as the foundation of the processes, with recycled and bio-based compositions not being commercially available.

In some embodiments, the sealing layer includes a coextrusion with a permeation-resistant material. In some embodiments, the coextrusion comprises a permeation-resistant material on the interior surface of the sealing layer. In some embodiments, the coextrusion comprises a permeation-resistant material on the exterior surface of the sealing layer. In some embodiments, the coextrusion comprises permeation-resistant material on both the interior surface and the exterior surface of the sealing layer.

Coextrusion can provide the following benefits: Materials having sufficient strength to withstand the process required to form the cylindrical inner layer of the cannular assembly may not have acceptable resistance to permeation. Conversely, permeation-resistant material may lack the strength for this formation process.

Permeation Barrier Resin Composition

Certain permeation-resistant materials may not have favorable physical or mechanical properties, on their own, for extrusion into layers. Advantageously, these materials may be mixed with a polymer resin, to provide a permeation barrier resin composition whose properties may be more suitable for extrusion. The polymer resin may be chosen from any material suitable for formation into the sealing layer, including any of the aforementioned materials, or mixtures thereof. The amount of permeation-resistant material in the permeation barrier resin composition is without limit. In some embodiments, the amount (w/w) of permeation-resistant material in the permeation barrier resin composition is at least 5%, optionally at least 10%, optionally at least 20%, optionally at least 30%, optionally at least 40%, optionally at least 50%, optionally at least 60%. In some embodiments, the amount (w/w) of permeation-resistant material in the permeation barrier resin composition is no more than 95%, optionally no more than 90%, optionally no more than 80%, optionally no more than 70%, optionally no more than 60%, optionally no more than 50%, optionally no more than 40%, optionally no more than 30%.

In some embodiments, a method for the formation of the sealing layer comprises the steps of:
providing a permeation barrier resin composition comprising a first suitable resin for the sealing layer and a permeation-resistant material, and
coextruding the permeation barrier resin composition with a second suitable resin.

The first and second suitable resins may be the same or different. The coextrusion process may afford a rolled sheet stock material, one or two sides of which is composed of material derived from the permeation barrier resin composition. Formation of the sealing layer from this stock material may thereby provide the sealing layer for a cannular structure in which the interior surface, the exterior surface, or both the interior and exterior surfaces may comprise material derived from the permeation barrier resin composition.

In some embodiments, a method for the formation of the sealing layer comprises a first step of extruding a sheet of suitable resin, optionally further fashioned into rolls of stock material, followed by a second step of forming at least one layer from the permeation barrier resin composition. In some further embodiments, the second step comprises extruding permeation barrier resin composition onto at least one surface of the sheet obtained from the first step, thereby forming a layer comprising permeation-resistant material on at least one surface of the sealing layer.

The thickness of the layer comprising permeation-resistant material is without limit. In some embodiments, the thickness of this layer is at least 0.5 mm, optionally at least 1 mm, optionally at least 2 mm, optionally at least 5 mm, optionally at least 10 mm. In some embodiments, the thickness of this layer is no more than 20 mm thick, optionally no more than 10 mm thick, optionally no more than 5 mm thick.

The thickness of the underlying layer formed with the first suitable resin is without limit. the thickness of this layer is at least 1 mm, optionally at least 2 mm, optionally at least 5 mm, optionally at least 10 mm, optionally at least 20 mm. In some embodiments, the thickness of this layer is no more than 50 mm thick, optionally no more than 20 mm thick, optionally no more than 10 mm thick.

Overlay

Exterior to the sealing layer is an optional overlay. This layer can be of any standard thickness. In order to maximize its resistance to permeation, the overlay is preferably a monolithic film along the surface of the sealing layer.

In some embodiments, the overlay is manufactured from a single sheet of material. The overlay can contain an overlap between the edges of the material. Preferably, the overlap is 10% or more of the material. The overlap can range to as high as 90% of the material.

In some embodiments, the overlay is fused with the underlying sealing layer. This fusion can be accomplished by the manufacturing process described below, in which the material is applied to a warm sealing layer.

In some embodiments, the material is resistant to permeation by methane. In some embodiments, the permeability coefficient of methane through the material is 10×10⁻⁹ mol/(m×s×MPa) or less, optionally 5×10⁻⁹ mol/(m×s×MPa) or less, optionally 3×10⁻⁹ mol/(m×s×MPa) or less, optionally 2×10⁻⁹ mol/(m×s×MPa) or less.

In some embodiments, the material is resistant to permeation by hydrogen. In some embodiments, the permeability coefficient of hydrogen through the permeation-resistant material is 10×10⁻⁹ mol/(m×s×MPa) or less, optionally 5×10⁻⁹ mol/(m×s×MPa) or less, optionally 3×10⁻⁹ mol/(m×s×MPa) or less, optionally 2×10⁻⁹ mol (m×s×MPa) or less.

In some embodiments, the material is resistant to permeation by ammonia. In some embodiments, the permeability coefficient of ammonia through the material is 10×10⁻⁹ mol/(m×s×MPa) or less, optionally 5×10⁻⁹ mol (m×s×MPa) or less, optionally 3×10⁻⁹ mol (m×s×MPa) or less, optionally 2×10⁻⁹ mol/(m×s×MPa) or less.

In some embodiments, the material is resistant to permeation by carbon dioxide. In some embodiments, the permeability coefficient of carbon dioxide through the material is 10×10⁻⁹ mol/(m×s×MPa) or less, optionally 5×10⁻⁹ mol/(m×s×MPa) or less, optionally 3×10⁻⁹ mol/(m×s×MPa) or less, optionally 2×10⁻⁹ mol/(m×s×MPa) or less.

In some embodiments, the permeability coefficient is for the material at 0° C. In some embodiments, the permeability coefficient is for the material at 20° C. In some embodiments, the permeability coefficient is for the material at 40° C. In some embodiments, the permeability coefficient is for the material at 60° C. In some embodiments, the permeability coefficient is for the material at 80° C. In some embodiments, the permeability coefficient is for the material at 100° C. In some embodiments, the overlay adheres to the overlying axial layer. This adhesion can be the result of surface forces, including but not limited to static electricity. This adhesion can assist in maintaining proper alignment of the axial layer with the interior of the cannular assembly during manufacture. This alignment can be maintained by this adhesion until the hoop reinforcement layer is applied in a process, described below, that introduces a compressive force on the cannular assembly.

Axial Reinforcement Layer

The axial reinforcement layer is a functional layer, applied to the OD of the sealing layer in one or each cannular assembly in the TCS, imparting axial reinforcement and strength to the TCS to resist axial loading created by internal pressure.

The axial reinforcement layer can be made of any material that provides the required reinforcement. Individual axial reinforcement layers on different cannular assemblies can be made from different materials. By way of example only, the material can be chosen from para-aramid fiber, unidirectional fiberglass, carbon fiber, Kevlar, or HDPE fabric with or without pre-impregnated materials, such as epoxy, polyurethane, polyolefin, and EVA.

One or more of the axial reinforcement layers in an TCS may incorporate a sensor wire disclosed below, including but not limited to a Pd- or Pd-alloy coated tapered optical fiber. Most generally, the axial reinforcement layer will be made of individual twisted or braided carbon fiber micro-ropes or twisted or braided carbon fiber graphene hybrid micro-ropes aligned sequentially into filaments and bonded to each other with EVA or similar resin. The micro-ropes can be fabricated out of carbon fiber tow or carbon fiber graphene materials from 5 k to 600 k which are twisted to a specific torsion and orientation to increase the alignment and the subsequent strength of the micro-rope and subsequently the filament by assuring each strand is subjected uniformly when under strain. These micro-rope filaments can be bonded together longitudinally with EVA resin to create a sheet fabric. These micro-rope filaments can be bonded together to form a filament or tape. This filament or tape can be uniformly distributed along the axis of the structure. The micro-ropes can comprise the EVA-impregnated material described above. The micro-ropes can be bonded together to form a filament or tape. Preferentially, for the curved TCS, filaments of this micro-rope material will be employed.

Hoop Reinforcement Layers

The hoop reinforcement layers of the tubular composite structure are functional reinforcement layers applied helically to encircle the axial reinforcement layer for providing high resistance to hoop stresses created in the tubular composite structure from internal pressure. This layer most typically will be made from twisted carbon fiber tow or twisted carbon fiber graphene hybrid (micro-ropes); however, unidirectional carbon fiber or glass fiber, Kevlar, aramid, preferably para-aramid, or polyethylene fibers can be used as an iteration of this embodiment. The hoop reinforcement layer is wound over the axial reinforcement layer by way of external winders with storage spools. For applications that require additional hoop reinforcement, more than one hoop reinforcement layer can be incorporated into a cannular assembly. The more than one hoop reinforcement layers can be located adjacent or non-adjacent to each other. Preferably, a pair of hoop reinforcement layers located adjacent to each other will be wound with opposite handedness, e.g., one layer will be wound with a left-handed helix and the other layer will be wound with a right-handed helix.

One or more of the hoop reinforcement layers in an TCS may incorporate a sensor wire disclosed below, including but not limited to a Pd- or Pd-alloy coated tapered optical fiber.

Manufacture of Sealing Layer

In an embodiment, manufacture of an individual cannular assembly proceeds down the mandrel, with the first step being formation of the sealing layer. Successive steps apply material to the exterior of the growing cannular assembly, except for optional spray application to the interior of the cannular assembly at the end of the mandrel.

The plastic sheet material for the sealing layer can be precut, and can be delivered to the jobsite on large spools for use as manufacturing feedstock. The sealing layer material is dispensed by feeding the material into a set of opposing compressive and dynamic rollers thus both pulling the feedstock from the spool and pushing the feedstock into the centering rollers (if required) or the shaper fixture.

In certain embodiments, particularly if the feedstock material is of narrower width than the spool and is wound on the spool in a stepped side by side layered orientation it will enter a stationary centering mechanism prior to entering the shaper fixture. This mechanism utilizes a series of long steel cannular rollers situated in a serpentine orientation to center the material in line with the shaper fixture and mandrel if being pulled from the spool at an angle.

In certain embodiments, particularly if the width of the feedstock material—and thus the circumference of the sealing layer—must be controlled to a high precision, the feedstock material will then progress through a trimmer/beveler mechanism. As the material progresses through the trimmer/beveler mechanism the outside edges of the material feedstock are mechanically trimmed to the exact width required for the radial measure of the sealing layer. This trimming process also incorporates a bevel or miter in the edge of the material of opposing angles on opposite edges. These opposing angles create a smooth mitered joint when the sealing layer is formed into a cannular structure and the seam is welded, thereby providing a robust lengthwise seam on the newly formed cylindrical sealing layer. By mitering the seam, the material overlaps itself thereby increasing the integrity of the lengthwise seam.

It will be appreciated that joining opposite edges of sheet material, required to form the cylindrical sealing layer, may inadvertently provide a pathway for leakage of media, regardless of the nature of the bulk sealing layer. Care must be taken to ensure that the lengthwise seam in the sealing layer provides an adequate seal.

In some embodiments, the permeation barrier resin composition is utilized to form the lengthwise seam between opposite edges of sheet material. This resin composition may be combined with an ultraviolet (“UV”) curable material. This resin composition may be spot-cured with exposure to UV light after application, to provide a continuous leak-free surface.

In some embodiments, a seam sealing or adhesive material may be applied to the underside of the lengthwise seam after the joint is completed.

In the case of sealing layers having an interior leak-free surface, suitable hardware may be provided on the exterior of the forming mandrel, thereby allowing formation of the lengthwise seam during fabrication of the cannular assembly.

In the case of sealing layers having a exterior leak-free surface, suitable hardware may be provided on a station located exterior to the nascent cannular assembly downstream from the station for the manufacture of the sealing layer, thereby allowing formation of the lengthwise seam on the exterior of the surface of the sealing layer before it is enclosed by the subsequent cylindrical layer.

In certain embodiments, a shaper fixture, located downstream from the spools, the optional centering mechanism, and the optional trimmer/beveler, is employed. The concentric shaper fixture is a series of specifically oriented rollers and or structural segments oriented axially with a concentric and continuous reduction in radial aspect which compresses and subsequently forms the feedstock material into a cannular structure of the specified internal diameter as it progresses onto the forming mandrel with the seam miter now aligned and compressed for welding and overlay.

By way of the aforementioned components, the ribbonlike feedstock material for the sealing layer is manipulated into a cylindrical structure, preferably at the upstream end of the mandrel, with the two edges of the feedstock meeting at a longitudinal seam. The aligned and compressed seam is welded by fusion, UT, or thermal welding processes, depending on the sealing layer material composition and the thickness of the material.

Manufacture of Overlay

The overlay is applied to the surface of the completed cylindrical sealing layer. As this layer moves downstream on the mandrel, a station exterior to the mandrel applies the overlay material to its exterior. Directionality of the overlay on the cylindrical sealing layer is generally not critical, since the overlay is not chosen for its mechanical strength.

In an embodiment, an immobile station for application of the layer will provide a layer oriented in the longitudinal direction. Preferentially, the edges of the material will overlap to ensure complete coverage, with the overlap oriented in the longitudinal direction.

In an embodiment, the overlay will be applied with a winder that undergoes a rotational motion around the nascent cannular assembly. The combination of the downstream motion of the sealing layer with the rotational motion of the station will result in helical application of the overlay. Preferentially, the edges of the material will overlap to ensure complete coverage, with the overlap oriented in the helical direction.

Preferentially, the overlay will be applied to the sealing layer immediately after the forming and welding process. In this manner, the underlying sealing layer will still be warm from these operations. The residual warmth of the sealing layer will promote a bonding process between this layer and the overlay. The resulting combination of materials will be essentially monolithic as the result of this phenomenon.

In some embodiments, the overlay material is supplied as spools. These spools will be relatively compact, since the material can be relatively thin and non-bulky. The compact spools, combined with relatively low-profile winders, will ensure adequate spatial clearance between this station and the downstream station for application of the axial layer.

Manufacture of Axial Reinforcement Layer

Fabrication of the axial reinforcement layer proceeds subsequent to formation of the cylindrical sealing layer and application of the overlay. As this layer moves downstream on the mandrel, a station exterior to the mandrel applies the axial reinforcement material to its exterior. Material applied from the station will be oriented in the axial direction, i.e., parallel to the centerline of the cannular assembly. In order to envelop the entire cannular assembly, its entire surface, at any point in its circumference, will be covered with axial reinforcement material, either as a single cylinder of material, or as a plurality of strips of material, each covering an arc of the circumference.

Manufacture of Hoop Reinforcement Layer

Fabrication of the axial reinforcement layer proceeds subsequent to formation of the cylindrical sealing layer and application of the overlay and axial reinforcement layer. The hoop reinforcement layer is wound over the axial reinforcement layer by way of external winders with storage spools. For applications that require additional hoop reinforcement, more than one hoop reinforcement layer can be incorporated into a cannular assembly. The more than one hoop reinforcement layers can be located adjacent or non-adjacent to each other. Preferably, a pair of hoop reinforcement layers located adjacent to each other will be wound with opposite handedness, e.g., one layer will be wound with a left-handed helix and the other layer will be wound with a right-handed helix.

The hoop reinforcement layer material will be tensioned during application of this layer. As a result, the layer will provide a compressive (inward) force on the interior of the tubular composite structure. This compressive force will hold the overlay in place against the sealing layer, thereby guarding against formation of bubbles under this layer in the event of leakage from the underlying sealing layer.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A cannular assembly, comprising from innermost surface to outermost surface:
(a) a sealing layer,
(b) an optional overlay fabricated from a permeation-resistant material,
(c) an axial reinforcement layer,
(d) one or more hoop reinforcement layers, and
(e) a protective layer,
wherein at least one layer chosen from the sealing layer and the overlay is fabricated from a permeation-resistant material.

2. The cannular assembly as recited in claim 1, wherein the permeation-resistant material is chosen from PVDC, polyolefin, titanium oxide, aluminum oxide or nanocomposite metal hybrids.

3. The cannular assembly as recited in claim 1, wherein sealing layer comprises a material chosen from chosen from ABS, PE, HDPE, UHMWPE, Nylon, PEEK, PET, PSS, PDA, ETFE polycarbonate, and polyurethane.

4. The cannular assembly as recited in claim 1, wherein the cannular assembly comprises an overlay layer fabricated from a permeation-resistant material.

5. The cannular assembly as recited in claim 4, wherein the overlay is manufactured from a single sheet of material.

6. The cannular assembly as recited in claim 1, wherein the sealing layer is fabricated from a permeation-resistant material.

7. The cannular assembly as recited in claim 6, wherein the sealing layer is a coextrusion with a permeation-resistant material.

8. The cannular assembly as recited in claim 7, wherein the sealing layer coextrusion comprises a permeation-resistant material on the interior of the sealing layer.

9. The cannular assembly as recited in claim 7, wherein the sealing layer coextrusion comprises a permeation-resistant material on the exterior of the sealing layer.

10. The cannular assembly as recited in claim 7, wherein the sealing layer coextrusion comprises permeation-resistant material on both the interior surface and the exterior surface of the sealing layer.

11. The cannular assembly as recited in claim 1, wherein the sealing layer comprises:
a first sub-layer, fabricated from a first resin material, and
a second sub-layer, fabricated from a mixture of a second resin material and a permeation-resistant material.

12. The cannular assembly as recited in claim 11, wherein the permeation-resistant material is chosen from PVDC, polyolefin, titanium oxide, aluminum oxide or nanocomposite metal hybrids.

13. The cannular assembly as recited in claim 12, wherein the first resin material and the second resin material are chosen from chosen from ABS, PE, HDPE, UHMWPE, Nylon, PEEK, PET, PSS, PDA, ETFE polycarbonate, and polyurethane, or mixtures thereof.

14. The cannular assembly as recited in claim 13, wherein the first resin material and the second resin material are the same.

15. The cannular assembly as recited in claim 11, wherein the second sub-layer is located on the interior surface of the sealing layer.

16. The cannular assembly as recited in claim 11, wherein the second sub-layer is located on the exterior surface of the sealing layer.

17. The cannular assembly as recited in claim 1, wherein the sealing layer comprises:
a first sub-layer, fabricated from a first resin material,
a second sub-layer, fabricated from a mixture of a second resin material and a permeation-resistant material, located on the interior surface of the sealing layer, and
a third sub-layer, fabricated from a mixture of the second resin material and a permeation-resistant material, located on the exterior surface of the sealing layer.

18. The cannular assembly as recited in claim 17, wherein the permeation-resistant material is chosen from PVDC, polyolefin, titanium oxide, aluminum oxide or nanocomposite metal hybrids.

19. The cannular assembly as recited in claim 18, wherein the first resin material and the second resin material are chosen from chosen from ABS, PE, HDPE, UHMWPE, Nylon, PEEK, PET, PSS, PDA, ETFE polycarbonate, and polyurethane, or mixtures thereof.

20. The cannular assembly as recited in claim 19, wherein the first resin material and the second resin material are the same.

21. The cannular assembly as recited in claim 1, wherein the permeability coefficient of methane through the permeation-resistant material at 20° C. is 10×10⁻⁹ mol/(m×s×MPa) or less, optionally 5×10⁻⁹ mol (m×s×MPa) or less, optionally 3×10⁻⁹ mol/(m×s×MPa) or less, optionally 2×10⁻⁹ mol/(m×s×MPa) or less.

22. The cannular assembly as recited in claim 1, wherein the permeability coefficient of hydrogen through the permeation-resistant material at 20° C. is 10×10⁻⁹ mol (m×s×MPa) or less, optionally 5×10⁻⁹ mol/(m×s×MPa) or less, optionally 3×10⁻⁹ mol/(m×s×MPa) or less, optionally 2×10⁻⁹ mol/(m×s×MPa) or less.

23. The cannular assembly as recited in claim 1, wherein the permeability coefficient of ammonia through the permeation-resistant material at 20° C. is 10×10⁻⁹ mol/(m×s×MPa) or less, optionally 5×10⁻⁹ mol/(m×s×MPa) or less, optionally 3×10⁻⁹ mol/(m×s×MPa) or less, optionally 2×10⁻⁹ mol/(m×s×MPa) or less.

24. The cannular assembly as recited in claim 1, wherein the permeability coefficient of carbon dioxide through the permeation-resistant material at 20° C. is 10×10⁻⁹ mol/(m×s×MPa) or less, optionally 5×10⁻⁹ mol/(m×s×MPa) or less, optionally 3×10⁻⁹ mol/(m×s×MPa) or less, optionally 2×10⁻⁹ mol/(m×s×MPa) or less.

25. A method for manufacturing a cannular assembly, the method comprising the steps of:
forming an innermost sealing layer;
optionally, applying an overlay to the exterior of the sealing layer;
applying an axial reinforcement layer to the exterior of the overlay;
applying one or more hoop reinforcement layers to the exterior of the axial reinforcement layer; and
applying a protective layer to the exterior of the hoop reinforcement layer,
wherein at least one layer chosen from the sealing layer and the overlay is fabricated from a permeation-resistant material.

26. The method as recited in claim 25, wherein the sealing layer is plastic.

27. The method as recited in claim 26, wherein the sealing layer is fashioned into a cylinder from flat thermoplastic sheet feedstock.

28. The method as recited in claim 27, further comprising the steps of:
pulling a sheet of feedstock onto a forming mandrel;
trimming the sheet of feedstock to the desired width;
forming a bevel on each of the opposing sides of the sheet;
forming the sheet into a cylinder, thus positioning the bevels in proximity to each other, to form a lengthwise seam; and
sealing the seam.

29. The method as recited in claim 28, wherein the step of sealing the seam is accomplished with a process chosen from fusion, UT, and welding.

30. The method as recited in claim 28, wherein a permeation barrier resin composition is utilized in the step of sealing the seam, said composition comprising a polymer resin and a permeation-resistant material.

31. The method as recited in claim 30, wherein the permeation barrier resin composition further comprises a UV-curable resin.

32. The method as recited in claim 31, further comprising the step of exposing the lengthwise seam to UV light sufficient to cure the resin.

33. The method as recited in claim 28, further comprising the step of applying a material for sealing or adhering to the weld subsequent to formation of the seam.

34. The method as recited in claim 25, wherein the sealing layer is fashioned with the steps of:
providing a permeation barrier resin composition comprising a first resin for the sealing layer and a permeation-resistant material, and
coextruding the permeation barrier resin composition with a second resin.

35. The method as recited in claim 25, wherein the axial reinforcement layer comprises unidirectional Fiberglas, carbon fiber, Kevlar, or HDPE fabric material.

36. The method as recited in claim 35, further comprising the steps of:
providing the fabric material for the axial reinforcement layer;
aligning the fabric material over the exterior of the nascent cannular assembly;
draping the fabric material on the nascent cannular assembly;
tensioning the fabric material, thus positioning the opposite edges of the fabric material in proximity to each other, to form a lengthwise seam; and
sealing the seam by thermal weld.

37. The method as recited in claim 36, wherein the axial reinforcement layer imparts a compressive force on the nascent cannular assembly.

38. The method as recited in claim 25, wherein the hoop reinforcement layer comprises twisted or braided micro-ropes or twisted or braided carbon fiber graphene hybrid micro-ropes.

39. The method as recited in claim 38, further comprising the steps of:
mounting material for a first hoop reinforcement layer onto a first winding spool;
propelling a partially constructed tubular assembly enclosed in the axial reinforcement layer;
winding the hoop reinforcement layer from the first winding spool onto the axial reinforcement layer, thereby forming a first hoop reinforcement layer.

40. The method as recited in claim 39, wherein the first hoop reinforcement layer imparts a compressive force on the nascent cannular assembly.

41. The method as recited in claim 39, further comprising the steps of:
mounting material for the hoop reinforcement layer onto a second winding spool; and
winding the hoop reinforcement layer from the second winding spool onto the first hoop reinforcement layer, thereby forming a second hoop reinforcement layer.

42. The method as recited in claim 41, wherein the helices of hoop reinforcement layers from the first and second winding spools are of opposite handedness.

43. The method as recited in claim 41, wherein the second hoop reinforcement layer imparts a compressive force on the nascent cannular assembly.

44. The method as recited in claim 25, further comprising the step of fashioning a protective layer on the exterior of the hoop reinforcement layer.

45. The method as recited in claim 44, wherein the protective layer is chosen from nylon, tear-resistant PTFE, coated Fiberglas fabric, Tyvek, and polyethylene.

46. The method as recited in claim 45, further comprising the steps of:
propelling a partially constructed tubular assembly enclosed in hoop reinforcement layer;
helically wrapping the protective layer material onto the hoop reinforcement layer; and
applying heat to the exterior of the protective layer material.

47. The method as recited in claim 25, comprising the step of applying an overlay to the exterior of the sealing layer.

48. The cannular assembly manufactured by the method of claim 25.

49. A mobile onsite factory (“MOF”), comprising:
a forming mandrel;
a station for the formation of a sealing layer;
optionally, a station for the formation of an overlay on the surface of the sealing layer;
a station for application of an axial layer on the surface of the overlay, the station comprising one or more applicators; and
a station for application of a hoop layer on the surface of the axial layer, the station comprising one or more applicators.

50. The MOF as recited in claim 49, further comprising a station for the formation of a sensor array layer.

51. The MOF as recited in claim 49, further comprising a station for the formation of a mesh-filled annulus.

52. The MOF as recited in claim 49, further comprising a station for the formation of a protective layer.

53. The MOF as recited in claim 49, wherein the station for the formation of a sealing layer comprises a joining device for joining opposite edges of the sealing layer, thereby providing a lengthwise seam for cylindrical sealing layer.

54. The MOF as recited in claim 49, wherein the joining device comprises a mechanism for applying a permeation barrier resin composition.

55. The MOF as recited in claim 54, wherein the joining device further comprises a mechanism for exposing the lengthwise seam to UV irradiation.

56. The MOF as recited in claim 54, wherein the joining device is provided on the exterior of the forming mandrel, thereby allowing formation of the lengthwise seam on the interior surface of the sealing layer during fabrication of the cannular assembly.

57. The MOF as recited in claim 54, wherein the joining device is provided on a station located exterior to the nascent cannular assembly downstream from the station for the manufacture of the sealing layer, thereby allowing formation of the lengthwise seam on the exterior of the surface of the sealing layer.

58. The MOF as recited in claim 49, further comprising a station for the formation of an overlay on the surface of the sealing layer.
